(19) United States
(12) Patent Application Publication
(10) Pub. No.: US 2012/0310742 A1
(43) Pub. Date: Dec. 6, 2012

(54) SYSTEMS AND METHODS FOR ADVERTISING ON SHIPPING CONTAINERS

(75) Inventors: Phillip Skinner, Sharpsburg, GA (US); Cyrll Turner, Atlanta, GA (US)

(73) Assignee: DAL Global Services,LLC, Atlanta, GA (US)

(21) Appl. No.: 13/486,997

(22) Filed: Jun. 1, 2012

Related U.S. Application Data
(60) Provisional application No. 61/492,315, filed on Jun. 1, 2011.

(51) Int. Cl. G06Q 30/02; G06Q 50/28

(52) U.S. Cl. 705/14.58; 705/14.66

(57) ABSTRACT

Systems and methods for distributing advertising materials to recipients of shipping containers is disclosed. A driver of a shipping company places an advertisement on the shipping container during delivery. The advertisement is preferably placed on the address label for enhanced visibility and consumer interaction. Systems and methods for target marking to recipients may preferably be employed to further enhance consumer response. A processing controller may be employed to determine the profile of the recipient of a shipping container, and an advertisement may be selected. A processing controller may determine which advertisement would most likely to be of interest to the recipient of the shipping container.

### RELATED APPLICATIONS

This application relates to, claims priority from, and incorporates herein by reference, as if fully set forth in U.S. Provisional Patent Application Ser. No. 61/492,315 filed on Jun. 1, 2011 and entitled “Advertising on Shipping Boxes.”

### BACKGROUND OF THE INVENTION

1. Field of the Invention

The present invention relates in general to advertising methods and systems. More particularly, the invention is directed to methods and systems for advertising on shipping containers.

2. Description of the Related Art

Annually, billions of dollars are spent by advertisers on post cards, bulk mail fliers, and other traditional advertising methods. The advertisers' goals are to make the public aware of their product offerings and to get their offering in the hands of potential customers.

FIG. 1 shows the typical process 101 for advertising via direct mail. The advertiser develops the ad, buys a mailing list, and submits the postcards to the post office with postage affixed (step 112). Note that a sub-process entails presorting in order to obtain a lower bulk mail rate. The Post Office delivers the postcard when sufficient capacity exists to do so (step 114). Note that the Post Office, and no other third party, handles direct mail. Consumers receive and possibly read the postcard (step 116). Given that consumers receive so much direct mail, it is often ignored and, consequently, redemption rates are low. In cases where there are redemptions of the offer, the advertiser benefits from incremental sales, profits, and market share gains (step 118). Hence, the conventional advertising approach is costly and not effective.

Accordingly, a need exists to reduce costs and improve the effectiveness of advertising.

### SUMMARY OF THE INVENTION

In a first aspect, a computer-implemented method of advertising on shipping containers is provided. The method comprising determining a profile of a recipient of a shipping container by a controller, selecting an advertisement based on the profile of the recipient, and affixing the advertisement on the shipping container.

In a first preferred embodiment of the method, the method further comprises determining a location of the recipient. The determining the profile further comprises determining the profile based on the location of the recipient. Affixing the advertisement preferably further comprises affixing the advertisement over an address label of the shipping container. Selecting an advertisement preferably further comprises selecting the advertisement based on the zip code of the recipient. Selecting an advertisement preferably further comprises selecting the advertisement based on whether the recipient resides in a home or an apartment. Selecting an advertisement preferably further comprises selecting the advertisement based on the day of the week. The advertisement preferably comprises a label having a low-tack adhesive. The advertisement preferably comprises an adhesion-free section configured for removing the label from the shipping container. Selecting an advertisement is preferably performed by the controller.

In a second aspect, a computer-implemented method of advertising on shipping containers is provided. The method comprises determining a recipient of a shipping container, retrieving a recipient profile of the recipient by a controller, and comparing the recipient profile with product profiles by the controller. The method further comprises selecting an advertisement based on the comparison, providing an advertisement label, and affixing the advertisement label on the shipping container.

In a second preferred embodiment, providing the advertisement label further comprises printing an ad on a label. Determining the recipient preferably comprises scanning information from an address label on the shipping container by a scanner, and communicating the information to the controller. Affixing the advertisement preferably further comprises affixing the advertisement over an address label of the shipping container. The method preferably further comprises determining a zip code of the recipient. Selecting an advertisement preferably further comprises selecting the advertisement based on the zip code of the recipient. The method preferably further comprises determining a day of delivery. The selecting an advertisement preferably further comprises selecting the advertisement based on the day of delivery. The advertisement label preferably comprises a label having a low-tack adhesive. Providing the advertisement label preferably comprises providing pre-printed advertisement labels.

In a third aspect, a system for distributing advertising materials to recipients of shipping containers is provided. The system comprises a marketing system having a database coupled to a processor, the processor configured for selecting an advertisement, and an advertisement generating device in communication with the marketing system, the advertisement generating device providing an advertising material.

In a third preferred embodiment, the system further comprises a scanner configured for scanning an address label of a shipping container, the scanner configured for communicating to the marketing system. The system preferably further comprises a printer configured for printing a label based on the selected advertisement.

These and other features and advantages of the invention will become more apparent with a description of preferred embodiments in reference to the associated drawings.

### DESCRIPTION OF THE DRAWINGS

FIG. 1 is a flow chart illustrating a process for advertising.

FIG. 2 is a flow chart illustrating exemplary actions for advertising on shipping containers in an embodiment.

FIG. 3 is a schematic illustration of a shipping container before an advertisement is placed on the container.

FIG. 4 is a schematic illustration of a shipping container having an advertisement placed over the address label.

FIG. 5 is a schematic block diagram of an exemplary system for advertising on shipping containers.

FIG. 6 is a flow chart illustrating exemplary actions for employing target marketing in an embodiment.

FIG. 7 is a schematic block diagram of a preferred marketing system employing a controller.

FIG. 8 is a flow chart illustrating exemplary actions for employing target marketing in an embodiment.

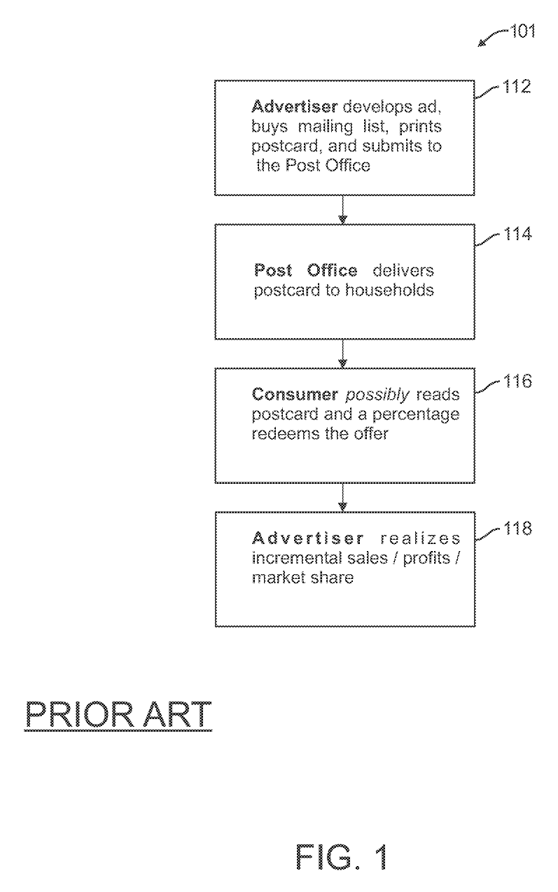

### DETAILED DESCRIPTION OF THE PREFERRED EMBODIMENTS

The following preferred embodiments are directed to systems and methods for advertising marketing materials on shipping boxes and containers. Such systems and methods may be incorporated into existing shipping systems. In an embodiment, a label having an advertisement is affixed to a shipping container before the shipping container is delivered to the recipient. The driver or other delivery personnel place the advertisement preferably over the address label. Target marketing of advertising may be employed in one or more embodiments. A marketing system may be preferably employed to effectively target individual consumers based on consumer profiles.

Embodiments provide advertisers with a better means of communicating their message to their customers by placing advertisements on shipping containers. The recipient is, in most cases, looking forward to receiving the shipment and is therefore much more likely to actually see and consider the advertisers' material. Embodiments allow shippers to maximize their revenue stream by tapping into this previously unused resource. The exterior of the shipping container provides a prominent display area for advertising and thus a great opportunity to generate incremental revenues by selling the space to advertisers. As used herein, the terms “shipping container” or “package” refer to packaging employed for shipping items and may include, for example, boxes, letters, cartons, packaging, tubes, and trunks.

Embodiments involve the placement of advertising on the exterior of boxes that are being shipped. Daily, millions of shipping containers such as boxes and packages are shipped worldwide with either no markings or generic markings of the box manufacturer or shipper on the outside of the box or package. For each of these packages that are being shipped, someone is already paying the cost of shipping.

The outside of these packages provide a “blank billboard” for advertisers to use at a fraction of the normal distribution cost because the shipping cost has already been covered by either the shipper or recipient of the shipment. Recipients of the shipment are more likely to see their advertisements than conventional bulk mail ads because recipients are anticipating receipt of the shipment and will most certainly interact with this package, versus simply discarding a bulk mailing without even opening it. Placing advertising on the exterior of packages/boxes—and most preferably on top of the addresses by the driver as it is being delivered—provide a secondary means of revenue generation for the shipper allowing the shipper to either increase profitability or compete more aggressively on the pricing of their traditional shipping business to increase market share. Due to high mis-delivery rates, recipients are conditioned into checking the address first to ensure the package is for them, and not a neighbor.

Embodiments solve the problem of the high distribution cost of advertising materials. Millions of dollars are spent annually getting the advertisers message to the target customer. A large percentage of that cost is the cost of shipping, namely, mailing and/or transportation. By having the advertisement “piggyback” on a package that is already being shipped, a large percentage of the incremental distribution cost can be avoided. Another problem is getting the recipient of advertising to actually view the advertisement instead of just throwing it away. The vast majority of bulk advertising material is never even read. With this approach, because the recipient is in most cases looking forward to receiving the shipment, they are much more likely to actually see and consider the advertisers' material. The marginal cost of delivery is almost nothing. The driver is already delivering. The only cost is the printing of the semi-adhesive ad and the few seconds of time at the driver's pay rate. This would be the lowest cost of physical advertising.

Embodiments offer high visibility advertisements on the exterior of shipping containers. Hence advertisers are able to reach a significantly higher percentage of their target customers with a guaranteed brand impression. The distribution cost is a fraction of the costs of traditional direct mail. Therefore, advertisers can achieve more reach with limited advertising budgets. Because more customers see the advertising, advertisers can expect a higher percentage of sales off the advertising thus increasing revenues and market share. This approach enables FedEx, UPS and other third party shippers to get into the direct mail business, which previously was the sole domain of the Post Office. By using this vacant area on the exterior of their boxes for advertising, shippers create an additional revenue stream beyond their traditional shipping fees. These fees may increase profit and/or be a means to subsidize shipping fees to be more competitive. This approach may be used to convey promotional offers such as sweepstakes, or deeply discounted temporary deals. Embodiments may provide significant benefits as compared to convention approaches. For example, embodiments may reduce the cost of distributing advertising materials up to 80% per unit. Increased visibility of advertising materials as compared to traditional means may provide a guaranteed brand impression. Advertisers may enjoy an increased redemption rate due to a higher “open rate.” Embodiments may provide an incremental revenue stream for shippers and/or box manufacturers.

As a basis of comparison, a typical postcard costs about 35¢ to deliver, including about 5¢ for a mailing list, 5¢ for printing and 25¢ (or over 70% of the total cost) for mailing, assuming that it is bulk, and presorted with bar codes. So any savings on the mailing cost would be advantageous. The marginal cost of a driver placing a semi-adhesive ad on top of the address would cost pennies.

Furthermore the “effective cost” of delivering a postcard is actually greater than 35¢. Even at a 3% redemption rate (which is high), the effective cost is $11.67 (35¢÷3%). So if the shipping company charged 5¢ for distribution, the total cost would be 10¢ including printing (no need to purchase a mailing list). So at a higher redemption rate of about 5%, the “effective cost” of this new approach is $2.00 (10¢÷5%), or an 80% or greater savings to the “effective cost” versus traditional post cards.

Embodiments allow advertisers to use the surface of shipping boxes and packages to reach out to their target customers. Embodiments enable shippers to augment their traditional revenue stream by taking advantage of the available space on the exterior of their shipping materials.

In one or more embodiments, a shipper makes advertising space available for sale on the exterior of their packages. The shipper and advertiser agree on target customers, advertising design, and rates. The shipper coordinates with the supplier to include advertiser art on packages as agreed. Through this process, shipper garners incremental revenues and advertisers are more successful in having their target customer see their products/offers.

Embodiments also solve the problem of capacity constraints of the post office. Unlike post cards or direct mail, there is no need to wait for available capacity at the post office. Not only would the preferred embodiments work on US Post Office packages, but also of those for FedEx, UPS and other shippers. Also capacity constraints usually occur in processing and sorting. The last point of contact, the driver, has almost infinite capacity. Conceivably, they could place ads on every delivered package.

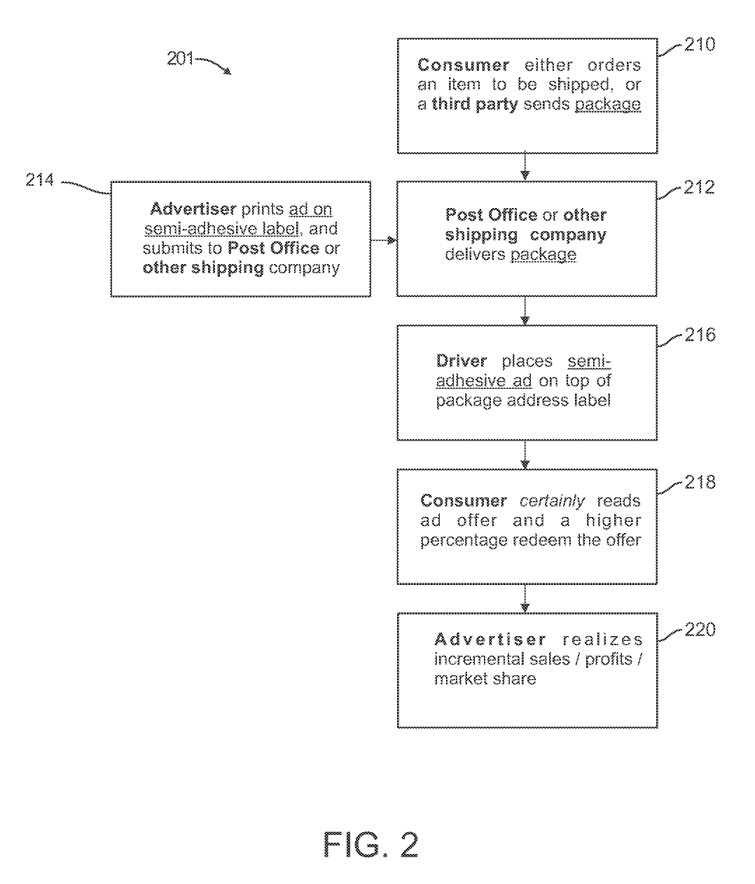

FIG. 2 illustrates an exemplary process 201 in one or more embodiments. Either the consumer initiates delivery of a package via a purchase, or a third party (e.g., a friend or a loved one) sends a package (step 210). In either case, the consumer has a positive mindset and a curiosity about the origin of the package. Independently advertisers can purchase ads with semi-adhesive backing to be placed on delivered packages (step 214). Shippers such as the U.S. Post Office, or private shippers deliver the package (step 212) As the driver delivers the package, the advertisement is preferably placed atop the addresses and/or prominently on the package (step 216). When the consumer receives the package they would read and peel advertisement in order to reveal the address (step 218). For the advertiser this is a guaranteed brand impression at a fraction of the cost compared to direct mail. As a result, the advertiser realizes incremental increase in sales, profits, or market share (step 220).

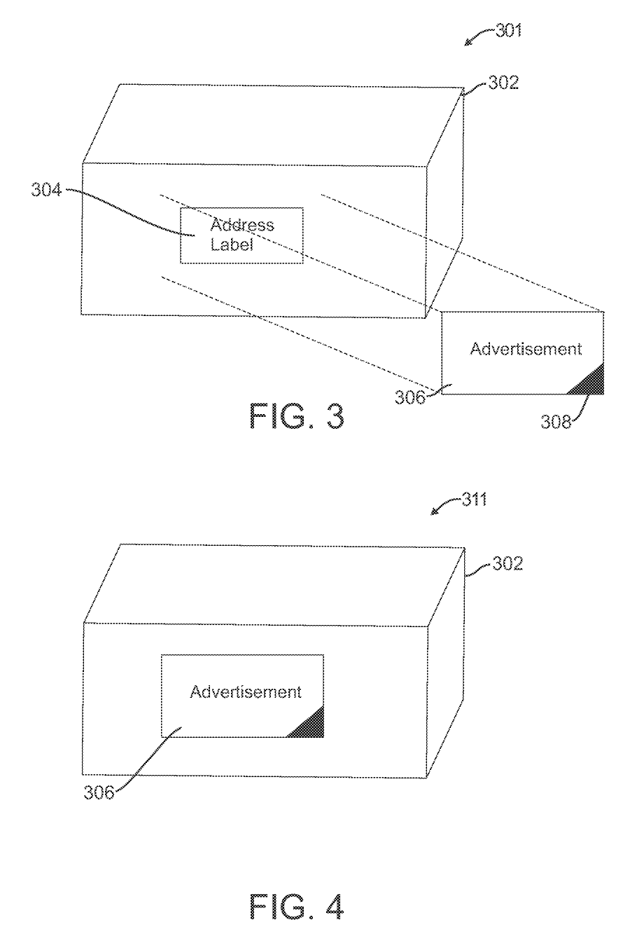

FIG. 3 is a schematic illustration 301 of a shipping container 302 before an advertisement 306 is placed on a typical package 302 prior to delivery. The address label 304 shows addresses for the origin and destination. The advertisement 306 is depicted before it is placed on top of the address label 304. In the preferred embodiment, the advertisement 306 has a semi-adhesive backing that can be peeled off without damaging the address label 304. One approach is to initially put the semi-adhesive next to the address at the point of shipment. Then at the final delivery point the driver peels it off the box and places it over the address. This approach works best for complimentary product advertising. For example, every Apple product box could have an offer for headphones. A premium can be charged for “over address” placement versus adjacent-address placement. A premium can also be charged for exclusive versus non-exclusive placement on a package.

FIG. 4 is a schematic illustration 311 of a shipping container 302 after the advertisement 306 is placed on the shipping container 302. In FIG. 4, the advertisement 306 is placed atop the address label 304. A corner 308 of the advertisement 306 has a “Peel Here” or similar message, indicating an area without adhesive backing. The consumer would peel off the advertisement 306, thereby revealing the addresses. Since consumers want to confirm that they are the true recipient of the package, and are curious about who sent it, they will necessarily read the advertisement 306 in order to reveal the addresses. The advertisement 306, or a second separate advertisement, may also be placed over the sender's address since recipients are naturally curious about who sent the package.

Marketers such as a proactive box manufacturer might also partner with customers to bring shippers and advertisers together to reach specific customer groups with product offerings that match a particular customer demographic. For example, advertising can be targeted to specific zip codes, homeowners versus renters, delivery dates and times during the week (e.g., Friday/Saturday for sporting and leisure event offers).

As discussed above, a package may also include a letter, i.e., standard mail, which tends be a more frequent vehicle for advertising than a boxed package which is more of an occasion item (e.g., gifts, online purchases, etc.). One approach would be to put delivered letters, i.e., letters which have reached their destination and are about to placed into the mailbox by the delivery person, inside a slightly oversized advertising pouch. The slightly larger pouch may include transparent sections to enable the recipient to see the letter inside and, thus, avoid discarding the entire pouch. This way, a recipient has to at least read the ad on the pouch in order to get to the bills, personal letters, etc.

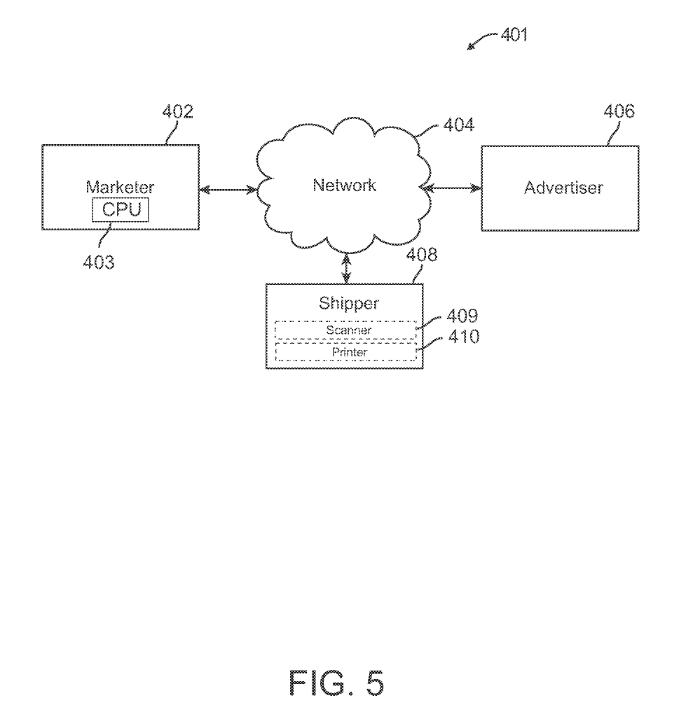

FIG. 5 illustrates an exemplary system 401 for implementing such an approach. In an embodiment, the marketer 402, the advertiser 406, and the shipper 408 are interconnected through the network 404. The marketer 402 may employ a processing controller 403, and the shipper 408 may have an optional scanner 409 and an optional printer 410 as discussed below. In one or more embodiments, the system and methods associated with the marketer 402 may be incorporated into and performed by the shipper 408 or the advertiser 406. In one or more embodiments, the marketer 402 may be a manufacturer or distributor of shipping containers.

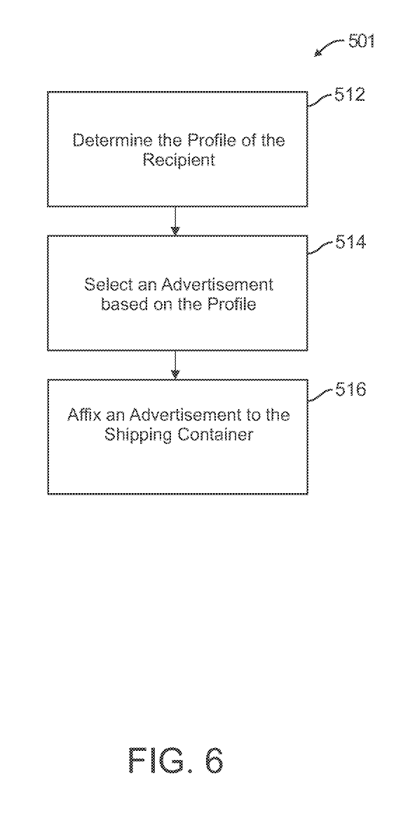

FIG. 6 presents an exemplary process 501 for target marketing to recipients. The profile of the recipient is determined (step 512). The profile may be determined based on location (e.g., zip code, city, state, geographical regions, as well as the specific street address), date of delivery (e.g., day of the week of the delivery, season, month), or type of destination (e.g. house, apartment, business) for example. This profile may be generated by a controller such as controller 403 for example. An advertisement is selected based on this profile (step 514). The selection of the advertisement may be performed by a controller such as controller 403 shown in FIG. 5 for example. The advertisement is affixed to the shipping container (step 516).

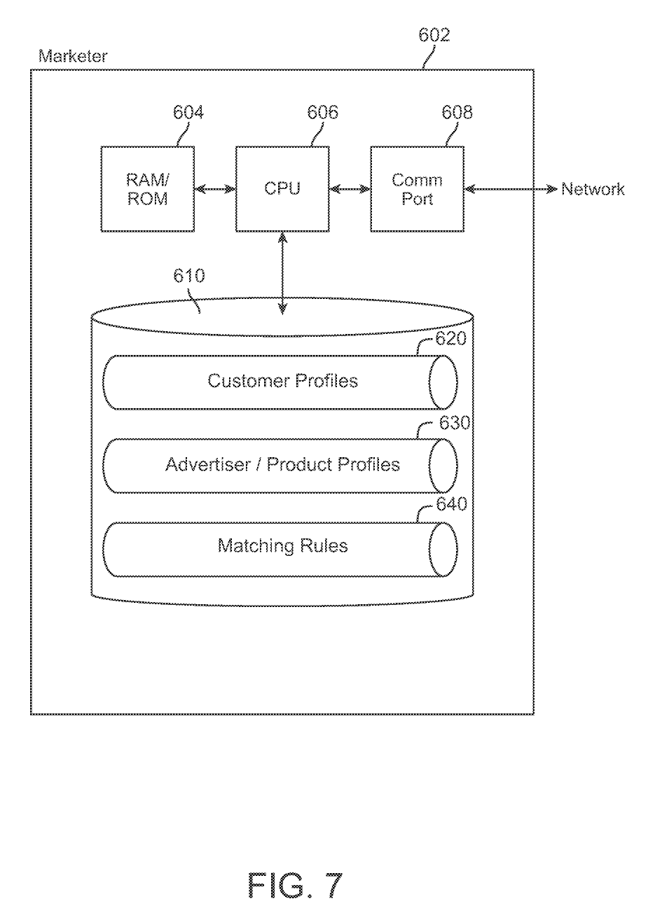

FIG. 7 is a schematic illustration of a preferred system 602 for target marketing based on individually identified recipients. The system 602 has a process controller 606 coupled with RAM/ROM memory 604 and a communication port 608 which may communicate through a network 404 as shown in FIG. 5. The controller 606 is connected to a database 610 which may have a customer profile database 620, an advertiser and product profile database 630 and a matching rules database 640. The customer profile database 620 may include data on the companies and types of businesses which have shipped to a particular recipient. This data could be categorized and sold to advertisers for targeting. For example, a recipient might have received packages from Orvis, BASS Pro Shop, and Browning. Therefore, this recipient would be classified as an “Outdoorsman”. In turn, the owner of the customer profile database 620, such as a package delivery company, could sell the address and name to the Outdoorsman Sport Shop and other similar advertisers or companies.

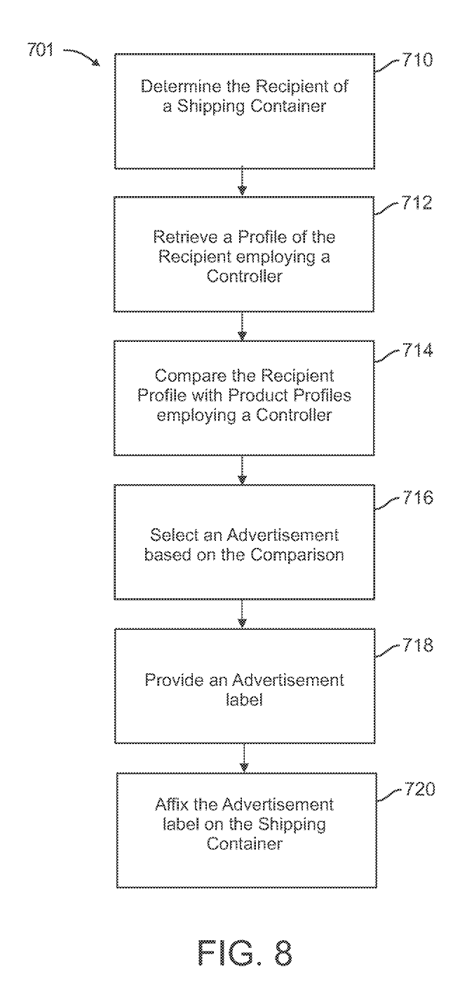

FIG. 8 shows an exemplary flow chart 701 illustrating a target marketing method. The recipient of the shipping container is determined in step 710. The recipient may be determined via the scanner 409 scanning the information on the address label and communicating this information to the controller 606 for example. A profile of the recipient is retrieved by the controller 606 in step 712. The controller 606 may communicate with the customer profile database 620 and obtain the profile of the recipient for example. The recipient profile is compared with the product profile in step 714. This comparison may be performed by the controller 606 interacting with the customer profile database 620, the advertiser and product profile database 630 and the matching rules database 640 for example. An advertisement is selected based on this comparison in step 716. An advertisement label is provided in step 718. The advertisement may be provided as a pre-printed label or may be printed by printer 410 for example. The advertisement label is affixed to the shipping container in step 720.

A preferred method of capturing data is also provided. A bar code, such as a Quick Response Code (“QR Code”) or a phone number may be provided, such that engagement by the recipient can be tracked.

Although the invention has been discussed with reference to specific embodiments, it is apparent and should be understood that the concept can be otherwise embodied to achieve the advantages discussed. The preferred embodiments above have been described primarily as systems and methods for distributing advertising materials on shipping containers. In this regard, the foregoing description of the system and methods is present for purposes of illustration and description. Furthermore, the description is not intended to limit the invention to the form disclosed herein. Accordingly, variants and modifications consistent with the following teachings, skill, and knowledge of the relevant art, are within the scope of the present invention. The embodiments described herein are further intended to explain modes known for practicing the invention disclosed herewith and to enable others skilled in the art to utilize the invention in equivalent, or alternative embodiments and with various modifications considered necessary by the particular application(s) or use(s) of the present invention.

What is claimed is:

1. A computer-implemented method of advertising on shipping containers, the method comprising:
determining a profile of a recipient of a shipping container by a controller;
selecting an advertisement based on the profile of the recipient; and,
affixing the advertisement on the shipping container.

2. The computer-implemented method of advertising on shipping containers on shipping containers of claim 1, further comprising:
determining a location of the recipient;
wherein determining the profile further comprises determining the profile based on the location of the recipient.

3. The computer-implemented method of advertising on shipping containers of claim 1, wherein affixing the advertisement further comprises affixing the advertisement over an address label of the shipping container.

4. The computer-implemented method of advertising on shipping containers of claim 1, wherein selecting an advertisement further comprises selecting the advertisement based on the zip code of the recipient.

5. The computer-implemented method of advertising on shipping containers of claim 1, wherein selecting an advertisement further comprises selecting the advertisement based on whether the recipient resides in a home or an apartment.

6. The computer-implemented method of advertising on shipping containers of claim 1, wherein selecting an advertisement further comprises selecting the advertisement based on the day of the week.

7. The computer-implemented method of advertising on shipping containers of claim 1, wherein the advertisement comprises a label having a low-tack adhesive.

8. The computer-implemented method of advertising on shipping containers of claim 1, wherein the advertisement comprises an adhesion-free section configured for removing the label from the shipping container.

9. The computer-implemented method of advertising on shipping containers of claim 1, wherein selecting an advertisement is performed by the controller.

10. A computer-implemented method of advertising on shipping containers, the method comprising:
determining a recipient of a shipping container;
retrieving a recipient profile of the recipient by a controller;
comparing the recipient profile with product profiles by the controller;
selecting an advertisement based on the comparison;
providing an advertisement label; and,
affixing the advertisement label on the shipping container.

11. The computer-implemented method of advertising on shipping containers of claim 10, wherein providing the advertisement label further comprises printing an ad on a label.

12. The computer-implemented method of advertising on shipping containers of claim 10, wherein determining the recipient comprises:
scanning information from an address label on the shipping container by a scanner; and,
communicating the information to the controller.

13. The computer-implemented method of advertising on shipping containers of claim 10, wherein affixing the advertisement further comprises affixing the advertisement over an address label of the shipping container.

14. The computer-implemented method of advertising on shipping containers of claim 10, further comprising determining a zip code of the recipient, wherein selecting an advertisement further comprises selecting the advertisement based on the zip code of the recipient.

15. The computer-implemented method of advertising on shipping containers of claim 10, further comprising determining a day of delivery, wherein selecting an advertisement further comprises selecting the advertisement based on the day of delivery.

16. The computer-implemented method of advertising on shipping containers of claim 10, wherein the advertisement label comprises a label having a low-tack adhesive.

17. The computer-implemented method of advertising on shipping containers of claim 10, wherein providing the advertisement label comprises providing pre-printed advertisement labels.

18. A system for distributing advertising materials to recipients of shipping containers, comprising:
a marketing system having a database coupled to a processor, the processor configured for selecting an advertisement; and,
an advertisement generating device in communication with the marketing system, the advertisement generating device providing an advertising material.

19. The system of claim 18, the system further comprising a scanner configured for scanning an address label of a shipping container, the scanner configured for communicating to the marketing system.

20. The system of claim 18, further comprising a printer configured for printing a label based on the selected advertisement.
